(19) United States
(12) Patent Application Publication
(10) Pub. No.: US 2014/0239889 A1
(43) Pub. Date: Aug. 28, 2014

(54) WIRELESS CHARGING SYSTEM

(71) Applicant: Renesas Electronics Corporation, Kawasaki-shi (JP)

(72) Inventor: Takefumi Endo, Kanagawa (JP)

(73) Assignee: Renesas Electronics Corporation, Kawasaki-shi (JP)

(21) Appl. No.: 14/178,369

(22) Filed: Feb. 12, 2014

(30) Foreign Application Priority Data
Feb. 28, 2013 (JP) 2013-039940

(51) Int. Cl. H02J 7/02

(52) U.S. Cl. CPC H02J 7/025
USPC 320/108

(57) ABSTRACT

A wireless charging system includes a power transmission unit for transmitting power and a power reception unit for receiving the power transmitted from the power transmission unit in a non-contact manner and supplying the power to a receiving load. The transmission unit includes a power transmission coil for generating a magnetic field based on an alternating voltage supplied. The power reception unit includes a power reception coil for generating an induction voltage by electromagnetic induction from the magnetic field generated by the power transmission coil, a rectifying unit for rectifying and smoothing the induction voltage generated by the power reception coil, and a voltage step-down unit for stepping down a direct voltage outputted from the rectifying unit. A winding ratio of the power transmission coil and the power reception coil is 1:n where n is an integer larger than 1.

### CROSS-REFERENCE TO RELATED APPLICATION

The present application claims priority from Japanese Patent Application No. 2013-039940 filed on Feb. 28, 2013, the content of which is hereby incorporated by reference into this application.

### TECHNICAL FIELD OF THE INVENTION

The present invention relates to a wireless charging system, and relates to technology applicable to wireless charging for, for example, mobile electronic devices.

### BACKGROUND OF THE INVENTION

In recent years, for some of portable electronic devices such as mobile phones and digital cameras, non-contact charging that is called wireless charging via electromagnetic induction can be used.

As such a wireless charging, for example, a wireless charging system of electromagnetic induction type has been known, which is defined by the protocols of the Qi standard established by the Wireless Power Consortium (WPC) which is an industry group related to wireless charging technology.

This kind of wireless charging system has a primary coil and a secondary coil. The primary coil and secondary coil are coils used for electric power transmission by electromagnetic induction. The primary coil is a power transmission coil and provided on the power transmission side such as a charging stand or a charging station. The secondary coil is a power reception coil and provided in a main body of a portable electronic device that is on the power reception side.

In addition, a winding ratio of the primary coil and the secondary coil is set to 1:1 and alternating power is wirelessly transmitted from the primary coil and received via the secondary coil, and then rectified so that the power is used as charging voltage.

Note that this kind of wireless charging technology includes, for example, AC/DC converting and supplying an output to a battery as charging current, the output having been retrieved by inducing coils of low-power wireless equipment by a magnetic field radiated from a switching power supply unit of power supply equipment (e.g., see Japanese Patent Application Laid-Open Publication No. 07-170668 (Patent Document 1)).

### SUMMARY OF THE INVENTION

Charging technology using such a wireless charging system as described above, however, has the following problems according to findings by the inventor.

To portable electronic devices, demands for increasing battery current is increasing for increasing the capacity of secondary batteries and shortening charging time. As mentioned above, when the wiring ratio of coils is 1:1, if loss is not taken into consideration for simplification, the same current as consumption current on the primary coil side flows into the secondary coil or a rectifier circuit for rectifying an output voltage flowed from the secondary coil.

Charging efficiency of lithium ion batteries for secondary batteries often used in portable electronic devices is lowered in low-temperature environment (e.g., lower than or equal to 10° C.) or high-temperature environment (e.g., higher than or equal to 40° C.). Thus, to efficiently charge lithium ion batteries, temperature management is important.

However, when charging current is increased, a loss amount following the increase of charging current is also increased. As a result, temperature of the secondary coil is increased. Problematically, influences of the temperature increase the temperature of the lithium ion battery high, lower the charging efficiency, and elongate charging time.

The above and other preferred aims and novel characteristics of the present invention will be apparent from the description of the present specification and the accompanying drawings.

The typical ones of the inventions disclosed in the present application will be briefly described as follows.

A wireless charging system according to an embodiment has features as follows.

The wireless charging system includes a power transmission unit for transmitting power, and a power reception unit for receiving the power transmitted from the power transmission unit in a non-contact manner and supplying the power to a receiving load.

The power transmission unit includes a power transmission coil for generating a magnetic field based on an alternating voltage supplied. The power reception unit includes a power reception coil for generating an induction voltage by electromagnetic induction from the magnetic field generated by the power transmission coil, a rectifying unit for rectifying and smoothing the induction voltage generated by the power reception coil, and a voltage step-down unit for stepping down a direct voltage outputted from the rectifying unit. In addition, a winding ratio of the power transmission coil and the power reception coil is 1:n where n is an integer larger than 1.

According to the embodiment, charging efficiency can be improved.

### BRIEF DESCRIPTIONS OF THE DRAWINGS

FIG. 1 is an explanatory diagram illustrating an example of a basic configuration in a wireless charging system according to a first embodiment;

FIG. 2 is an explanatory diagram illustrating a more specific configuration example of the wireless charging system in FIG. 1;

FIG. 3 is an explanatory diagram illustrating a configuration example of a wireless charging system studied by the inventor, in which a winding ratio of a transmission coil and a reception coil is 1:1;

FIG. 4A is an explanatory diagram explaining a mechanism capable of suppressing loss;

FIG. 4B is an explanatory diagram explaining the mechanism capable of suppressing loss;

FIG. 5A is an explanatory diagram explaining a mechanism of reducing a wire diameter of a reception coil;

FIG. 5B is an explanatory diagram explaining the mechanism of reducing the wire diameter of a reception coil;

FIG. 6 is an explanatory diagram illustrating an example of a configuration of a constant-voltage type wireless charging system according to a second embodiment;

FIG. 7 is an explanatory diagram illustrating an example of a configuration of a constant-rate stepping-down type wireless charging system according to a third embodiment;

FIG. 8 is an explanatory diagram illustrating an example of a voltage profile/current profile of charging control of a battery using a control circuit that is provided in the wireless charging system in FIG. 7; and

FIG. 9 is an explanatory diagram illustrating an example of a configuration of a constant-voltage type wireless charging system according to the third embodiment.

### DESCRIPTIONS OF THE PREFERRED EMBODIMENTS

In the embodiments described below, the invention will be described in a plurality of sections or embodiments when required as a matter of convenience. However, these sections or embodiments are not irrelevant to each other unless otherwise stated, and the one relates to the entire or a part of the other as a modification example, details, or a supplementary explanation thereof.

Also, in the embodiments described below, when referring to the number of elements (including number of pieces, values, amount, range, and the like), the number of the elements is not limited to a specific number unless otherwise stated or except the case where the number is apparently limited to a specific number in principle. The number larger or smaller than the specified number is also applicable.

Further, in the embodiments described below, it goes without saying that the components (including element steps) are not always indispensable unless otherwise stated or except the case where the components are apparently indispensable in principle.

Similarly, in the embodiments described below, when the shape of the components, positional relation thereof, and the like are mentioned, the substantially approximate and similar shapes and the like are included therein unless otherwise stated or except the case where it is conceivable that they are apparently excluded in principle. The same goes for the numerical value and the range described above.

Also, components having the same function are denoted by the same reference symbols throughout the drawings for describing the embodiments, and a repetitive description thereof is omitted. Also, in some drawings used in the embodiments, hatching is used even in a plan view so as to make the drawings easy to see.

### First Embodiment

<Summary of Embodiments>

A summary of the embodiments is a wireless charging system (wireless charging system WPS) having a power transmission unit (transmission unit PTB) and a power reception unit (reception unit PRB). The power transmission unit transmits power, and the power reception unit receives the power transmitted from the power transmission unit in a non-contact manner and supplies the power to a reception-side load (battery BAT).

The power transmission unit has a transmission coil (transmission coil PTC) for generating a magnetic field based on an alternating voltage applied thereto. The power reception unit has a reception coil (reception coil PRC), a rectifying unit (rectifying unit REC), and a voltage step-down unit (voltage step-down unit CON).

A winding ratio of the transmission coil and the reception coil is 1:n. Moreover, n is an integer larger than 1.

Hereinafter, based on the summary described above, embodiments will be described in detail.

<Configuration Example of the Wireless Charging System>

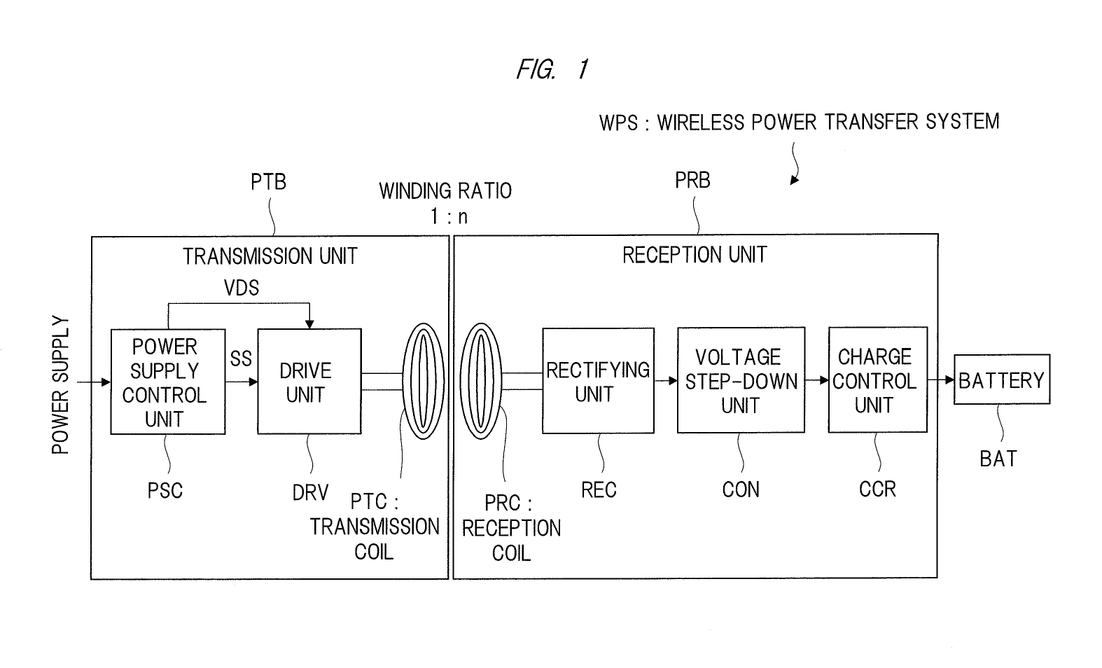

FIG. 1 is an explanatory diagram illustrating an example of a basic configuration of a wireless charging system according to a first embodiment.

The wireless charging system WPS is configured of, as illustrated in FIG. 1, the transmission unit PTB is provided to, for example, a charging stage or a charging station. The reception unit PRB is provided to a portable electronic device such as a mobile phone or a digital camera to be charged.

Upon charging portable electronic devices, the electronic device is disposed on a charging stage or a charging station so that the portable electronic device is charged in a non-contact manner via electromagnetic induction that is called close-range magnetic induction.

The transmission unit PTB includes a power supply control unit PSC, a driver unit DRV, and a transmission coil PTC. The reception unit PRB includes a reception coil PRC, a rectifying unit REC, a voltage step-down unit CON, and a charge control unit CCR.

The power supply control unit PSC converts the inputted alternating voltage to a direct voltage and outputs a power supply for switching VDS to the driver unit DRV as well as generating a switching signal SS and outputting the same to the driver unit DRV.

The driver unit DRV includes a transistor such as a MOS-FET (Metal Oxide Semiconductor Field Effect Transistor) and, based on the switching signal SS outputted from the power supply control unit PSC, switches the power supply for switching VDS generated by the power supply control unit PSC to drive the transmission coil PTC.

Between the transmission coil PTC and the reception coil PRC, power transfer via inductive coupling is performed. As the transmission coil PTC is driven by the driver unit DRV, an alternating current running through the transmission coil PTC generates a magnetic field. As a result, an inductive voltage is generated to the reception coil PRC.

The rectifying unit REC is composed of, for example, a diode bridge circuit and a smoothing circuit such as a capacitor. The rectifying unit REC converts the alternating voltage generated by the reception coil PRC to a direct voltage and smoothes the direct voltage. The voltage step-down unit CON lowers a voltage level of the direct voltage converted by the rectifying unit REC, that is, lowers the voltage. A stepped-down voltage outputted from the voltage step-down unit CON is inputted to the charge control unit CCR.

To the charge control unit CCR, a battery BAT that is a secondary battery such as a lithium ion battery is connected. The charge control unit CCR controls charging of the battery BAT and supplies the inputted stepped-down voltage to the battery BAT as a charging voltage.

<Configuration Example of Transmission Coil and Reception Coil>

Here, a configuration of the transmission coil PTC and the reception coil PRC is described.

In the wireless charging system WPS, a winding ratio of the transmission coil PTC that is a primary coil and the reception coil PRC that is a secondary coil is set to 1:n. The number “n” is an integer larger than 1.

In this manner, a voltage generated across two ends of the reception coil PRC is n-times a voltage of the transmission coil PTC. For example, when the winding ratio of the transmission coil PTC and the reception coil PRC is set to 1:3, as long as the power consumption is the same, the voltage generated across two ends of the reception coil PRC is about three times as large as the voltage generated when the winding ratio of the transmission coil PTC and the reception coil PRC is 1:1 and thus an amount of current can be reduced to about one-third of that with the winding ratio of 1:1.

An effect of the reduction in current works at the square of the current. Thus, as long as heat dissipation from the reception coil PRC is allowed, it is possible to reduce a diameter of wire rod, that is, to increase a resistance value and reduce a thickness of the reception coil PRC. It is effective for portable electronic devices which down-sizing and thickness reduction are requested.

The larger the “n” of the winding ratio of the reception coil PRC is, the more the amount of current can be reduced. However, as the n is increased, the voltage generated across two ends of the reception coil PRC is increased. When the voltage is high, a withstand voltage of the rectifying unit REC and the voltage step-down unit CON is problematic. Accordingly, in consideration of the withstand voltage of these circuits, the winding ratio of the transmission coil PTC and the reception coil PRC is preferable to be, for example, about 1:2 to about 1:3.

However, when there is a spare space in the withstand voltage of the rectifying unit REC, the voltage step-down unit CON, or a reception IC that includes the rectifying unit REC and the voltage step-down unit CON described later, the value of n may be larger than 3.

In this manner, by reducing the amount of current by increasing the number of “n”, power loss, that is, heat generation can be kept low. As a result, charging of the battery BAT can be stably and efficiently performed.

<Specific Configuration Example of the Wireless Charging System>

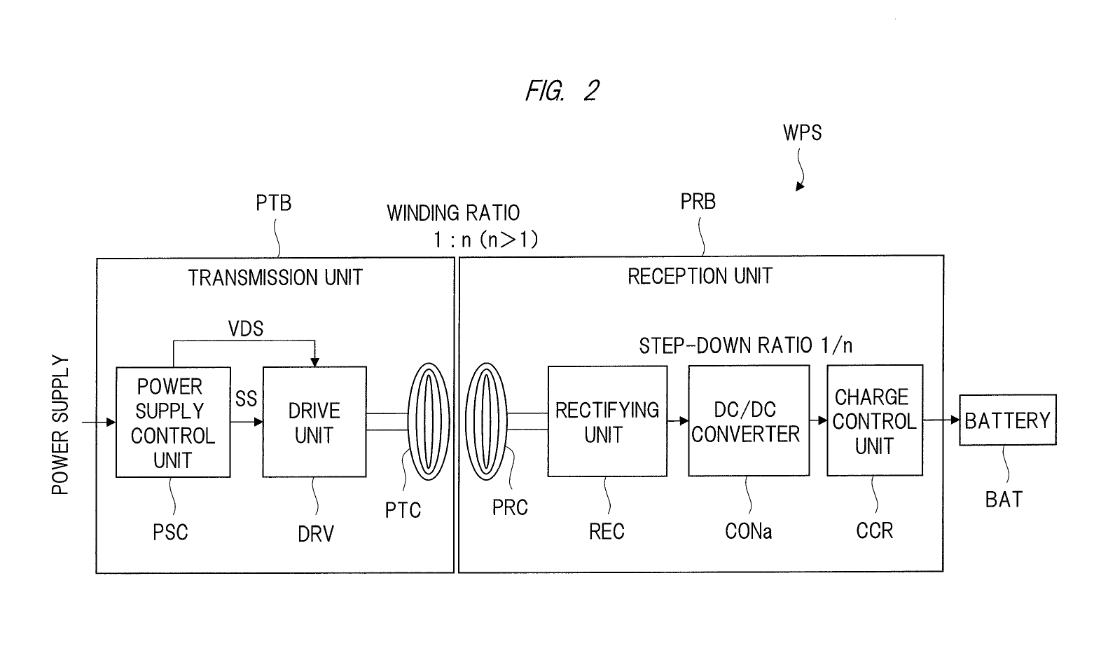

FIG. 2 is an explanatory diagram illustrating a more specific configuration example of the wireless charging system of FIG. 1.

FIG. 2 is an explanatory diagram of an example of a configuration of the wireless charging system of a constant-rate stepping down type.

In this case, the wireless charging system WPS outputs a direct voltage obtained by the rectification by the rectifying unit REC is stepped down at a constant stepping down rate and outputted to be supplied to the charge control unit CCR. This wireless charging system WPS of a constant-rate stepping down type is composed of the transmission unit PTB and the reception unit PRB as illustrated in FIG. 2. The transmission unit PTB has a configuration same as that of the transmission unit PTB in FIG. 1.

In addition, a configuration of the reception unit PRB has a DC/DC converter CONa as the voltage step-down unit CON in FIG. 1 provided therein. Regarding the other part of the reception unit PRB, a description is omitted since it is the same as that in FIG. 1.

The DC/DC converter CONa steps down and outputs a direct voltage obtained by rectification by the rectifying unit REC. A stepping-down ratio of the DC/DC converter CONa is constant and is set to be substantially the same as a winding ratio of the reception coil PRC.

Thus, when the winding ratio of the transmission coil PTC and the reception coil PRC is 1:n, the direct voltage inputted is stepped down to 1/n (one-nth) and outputted. For example, when the winding ratio of the transmission coil PTC and the reception coil PRC is 1:3, a voltage level of the inputted direct voltage is stepped down to about ⅓ of the same and outputted.

<Operation Example of the Wireless Charging System>

Next, an example of an operation of the wireless charging system WPS in FIG. 2 will be described.

As described above, when the winding ratio of the transmission coil PTC and the reception coil PRC is 1:n, across the two ends of the reception coil PRC, a voltage n times as large as a voltage on the transmission coil PTC side is generated.

Then, the rectifying unit REC rectifies an alternating voltage generated at the transmission coil PTC to create a direct voltage. Subsequently, the DC/DC converter CONa steps down the direct voltage outputted from the rectifying unit REC.

Here, since a stepping down ratio of an input/output voltage is set at 1/n for the DC/DC converter CONa, a stepped-down voltage outputted from the DC/DC converter CONa is converted to a voltage substantially the same as the voltage generated on the transmission coil PTC side.

The voltage stepped down by the DC/DC converter CONa is inputted to the charge control unit CCR so that the battery BAT is charged based on control by the charge control unit CCR.

Note that, while the battery BAT is charged via the charge control unit CCR in the example of the configuration of the wireless charging system WPS, the stepped down voltage outputted from the DC/DC converter CONa can be directly supplied to the electronic device side without passing through the charge control unit CCR.

In that case, to some of electronic devices such as mobile phones or smart phones, a charging control module for charging control of the battery BAT or the like is mounted. A stepped down voltage outputted from the voltage step-down unit CON is supplied to the charging control module and the battery BAT is charged by charging control of the charging control module.

<Configuration Example of the Wireless Charging System According to Studies by the Inventor>

Here, charging the battery BAT by the wireless charging system WPS illustrated in FIG. 2 at a power substantially the same as that upon charging a battery in a wireless charging system in which a winding ratio of a transmission coil and a reception coil is 1:1 will be thought about.

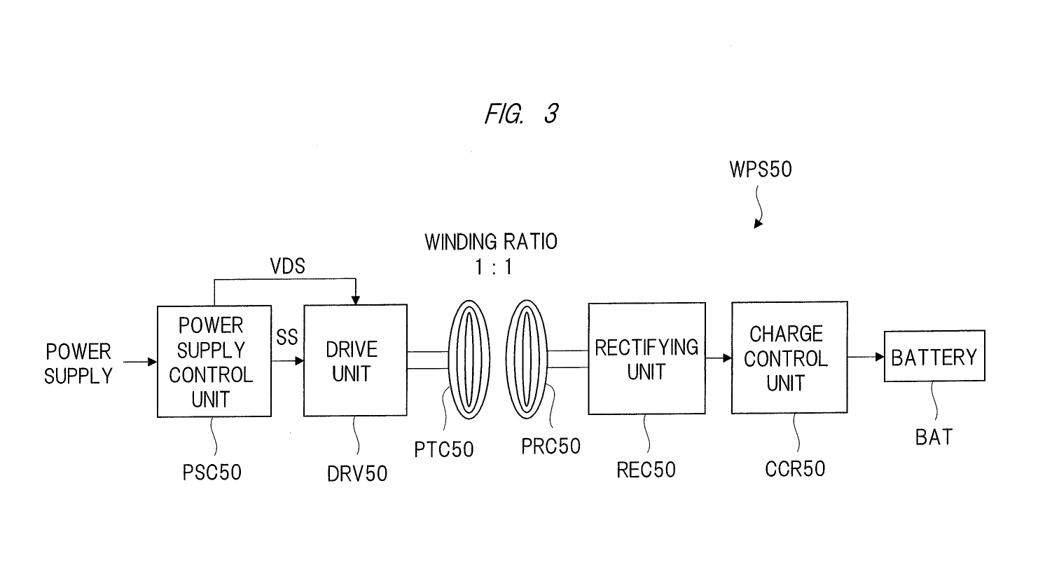

FIG. 3 is an explanatory diagram illustrating a configuration example of a wireless charging system WPS50, which has been studied by the inventor, in which a winding ratio of a transmission coil and a reception coil is 1:1.

In that case, the wireless charging system WPS50 includes, as illustrated in FIG. 3, a power supply control unit PSC50, a driver unit DRV50, a transmission coil PTC50, a reception coil PRC50, a rectifying unit REC50, and a charge control unit CCR50. The power supply control unit PSC50, the driver unit DRV50 and the transmission coil PTC50 configure a power transmission unit. The reception coil PRC50, the rectifying unit REC50, and the charge control unit CCR50 configures a power reception unit.

Here, a winding ratio of the transmission coil PTC50 and the reception coil PRC50 is set to 1:1 and thus a voltage generated across two ends of the reception coil PRC50 is substantially the same as that on the transmission coil PTC50 side.

An alternating voltage generated at two ends of the reception coil PRC50 is converted to a direct voltage by a rectifying unit REC50 and inputted to the charge control unit CCR50. To the charge control unit CCR50, a battery BAT that is a secondary battery such as a lithium ion battery is connected. The charge control unit CCR50 controls charging of the battery BAT and supplies an inputted voltage to the battery BAT as a charging voltage.

Here, the wireless charging system WPS50 in FIG. 3 and the wireless charging system WPS in FIG. 2 both handle power at a substantially the same level. However, the voltage applied to the reception coil PRC and the rectifying unit REC in the wireless charging system WPS in FIG. 2 is about n times as high as that of the wireless charging system WPS50 in FIG. 3.

Thus, current flowing in the reception coil PRC and the rectifying unit REC is reduced to about 1/n thereof as compared to that of the wireless charging system WPS50 in FIG. 3. In this manner, by reducing the amount of current, it is possible to significantly suppress loss in the reception coil PRC and the rectifying unit REC.

<Mechanism of Suppressing Loss>

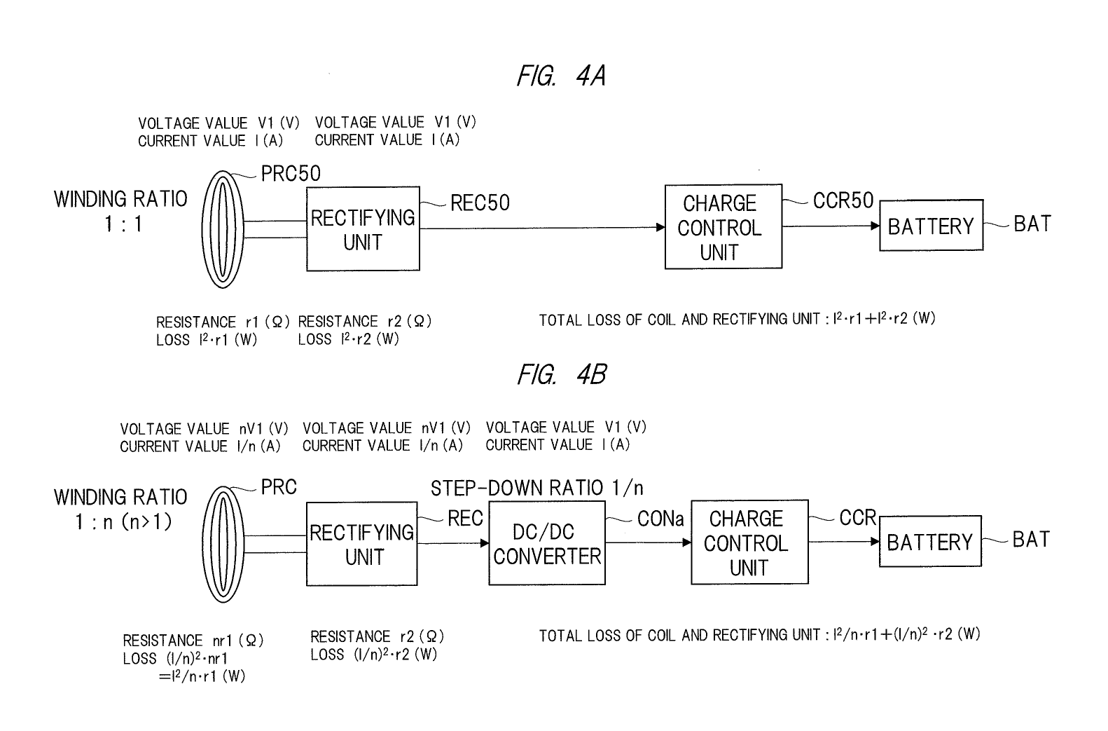

FIGS. 4A and 4B are explanatory diagrams of a mechanism capable of suppressing loss. FIG. 4A illustrates a reception unit of the wireless charging system WPS50 in FIG. 3 and FIG. 4B illustrates a reception unit PRB of the wireless charging system WPS in FIG. 2.

In the wireless charging system WPS50 in FIG. 3 in which the winding ratio is 1:1, as illustrated in FIG. 4A, when a resistance to be loss for the reception coil PRC50 is taken as a resistance r1 (Ω), loss in the reception coil PRC50 is expressed as loss (W)=I²×r1. In addition, when a resistance to be loss of the rectifying unit REC50 is expressed as loss (W)=I²×r2. Thus, total loss is expressed as I²×r1+I²×r2.

On the other hand, in the wireless charging system WPS in FIG. 2 according to the present embodiment, the voltage generated at the reception coil PRC is n times as large as a voltage applied to the transmission coil PTC and thus a flowing current is I/n (here, n is the winding ratio). Thus, as illustrated in FIG. 4B, when a resistance to be loss of the reception coil PRC is taken as resistance nr1 (Ω), loss at the reception coil PRC is expressed as loss (W)=(I/n)²×nr1.

In addition, when a resistance to be loss of the rectifying unit REC is taken as resistance r2 (Ω), the loss of rectifying unit REC is expressed as loss (W)=(I/n)²×r2. Thus, total loss of the reception coil PRC and the rectifying unit REC is expressed as loss (W)=loss (W)=I²/n×r1+(I/n)²×r2.

Here, even when the loss of DC/DC converter CONa is added, as a value of flowing current is increased, the effect of reducing loss of the reception coil PRC and the rectifying unit REC by the winding ratio n is increased. Thus, loss is suppressed by reducing the amount of current in the wireless charging system WPS in FIG. 2 even when the number of windings is increased with the same wire rod and wire diameter as those of the wireless charging system WPS50.

<Mechanism Capable of Reducing Wire Diameter of Coil>

Further, the wire diameter of the reception coil PRC can be reduced to reduce the flowing current to 1/n.

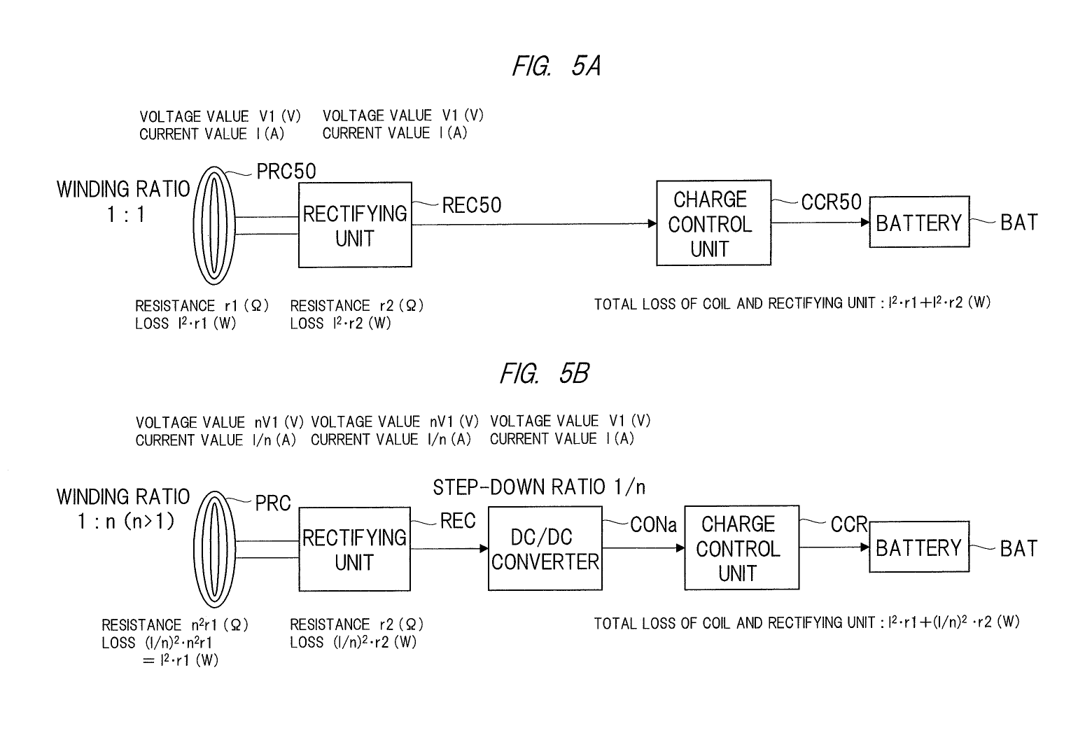

FIGS. 5A and 5B are explanatory diagrams of a mechanism for reducing the wire diameter of the reception coil. FIG. 5A illustrates a reception unit of the wireless charging system WPS50 in FIG. 3 and FIG. 5B illustrates the reception unit PRB of the wireless charging system WPS in FIG. 2.

Loss in the wireless charging system WPS50 in FIG. 3 in which the winding ratio is 1:1 is the same as that in FIG. 4A. On the other hand, in the wireless charging system WPS in FIG. 2 according to the present embodiment, when a reception coil PRC with a reduced wire diameter is used, as illustrated in FIG. 5B, when the resistance of the reception coil PRC is taken as n²r1 (Ω), loss of the reception coil PRC is at the same level as that in FIG. 5A as being expressed as loss (W)=(I/n)²×n²×r1=I²×r1. On the other hand, loss of the rectifying unit REC is expressed as loss (W)=(I/n)²×r2 in the same manner as FIG. 4B.

Thus, when loss at the same level as that of the reception coil PRC50 in the wireless charging system WPS50 in FIG. 5A is allowable, even when loss of the DC/DC converter CONa is added, as the value of flowing current is increased, the effect of reducing the loss of the rectifying unit REC at the winding ratio n is increased. Thus, the wire diameter can be reduced by increasing the resistance value of the coil.

In this manner, even when the number of windings is increased by reducing the wire diameter, when the winding is made in a concentric manner, the thickness of the coil can be reduced. Thus, there is a merit is brought in mounting coils having a limitation in thickness or the like.

In the above-described manner, it is possible to significantly suppress loss in the reception coil PRC and the rectifying unit REC and thus charging efficiency of the battery BAT can be improved.

### Second Embodiment

In a second embodiment, another specific configuration example of the wireless charging system WPS in FIG. 1 will be described.

<Configuration Example of Wireless Charging System>

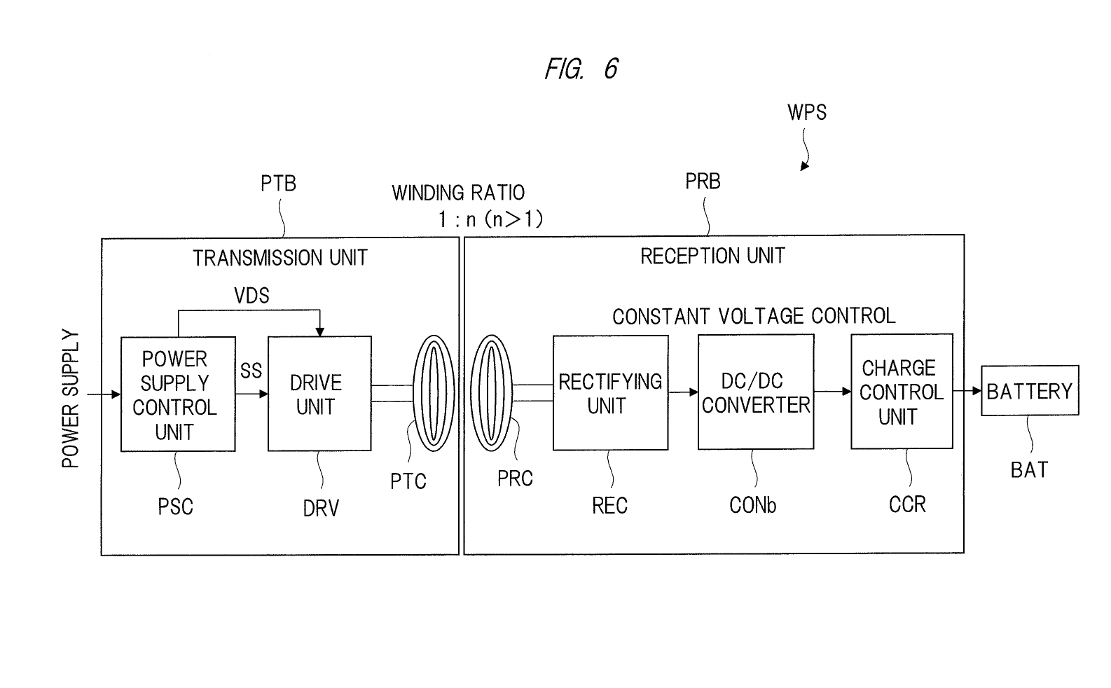

FIG. 6 is an explanatory diagram illustrating an example of a configuration in a wireless charging system of a constant voltage type according to the second embodiment.

In this case, a wireless charging system WPS steps down a direct voltage obtained by a rectification by a rectifying unit REC to a voltage level at a substantially constant level previously set and outputs and supplies the direct voltage to a charge control unit CCR. This wireless charging system WPS of the constant voltage type is composed of a transmission unit PTB and a reception unit PRB as illustrated in FIG. 6. A configuration of the transmission unit PTB is same as that of the transmission unit PTB in FIG. 1 of the first embodiment.

In addition, in the configuration of the reception unit PRB, as the voltage step-down unit CON in FIG. 1 of the first embodiment, a DC/DC converter CONb is provided. The other part of configuration in the reception unit PRB is the same as that in FIG. 1 and thus descriptions thereof is omitted.

The DC/DC converter CONb steps down a direct voltage obtained by rectification by the rectifying unit REC to a voltage level previously set and then outputs the same. The DC/DC converter CONb outputs a stepped-down voltage at a substantially constant voltage level regardless of the voltage level of the direct voltage outputted from the rectifying unit REC.

<Operation Example of Wireless Charging System>

Hereinafter, an example of an operation of the wireless charging system WPS in FIG. 6.

In the same manner as FIG. 2 in the first embodiment, when the winding ratio of the transmission coil PTC and the reception coil PRC is 1:n, across the two ends of the reception coil PRC, a voltage n times as large as a voltage on the transmission coil PTC side is generated.

The rectifying unit REC rectifies an alternating voltage generated at the transmission coil PTC to create a direct voltage. Subsequently, the DC/DC converter CONb steps down the direct voltage outputted from the rectifying unit REC. The DC/DC converter CONb steps down and outputs the direct voltage outputted from the rectifying unit REC and performs constant-voltage control to make the voltage outputted substantially constant.

Here, charging a battery BAT by the wireless charging system WPS illustrated in FIG. 6 with power that is substantially the same as the power for charging the wireless charging system in which the winding ratio is 1:1 in FIG. 3 will be thought about.

Also in this case, although the amount is not as much as the wireless charging system WPS in FIG. 2 reduces, the current flowing in the reception coil PRC and the rectifying unit REC can be reduced more as compared with the wireless charging system WPS50 illustrated in FIG. 3 of the first embodiment.

According to the above-described manner, it is possible to significantly suppress loss of the reception coil PRC and the rectifying unit REC. In addition, as the flowing current is reduced to about 1/n in the reception coil PRC, a wire diameter of the reception coil PRC can be reduced.

In this manner, even when the number of windings is increased by reducing the wire diameter, when the winding is made in a concentric manner, the thickness of the coil can be reduced. Thus, there is a merit is brought in mounting coils having a limitation in thickness or the like.

### Third Embodiment

In a wireless charging system according to a third embodiment, a voltage step-down unit (DC/DC converter CONa) for stepping down a direct voltage outputted from a rectifying unit steps down a voltage outputted from a rectifying unit to about 1−nth as large as the voltage.

Hereinafter, the third embodiment will be described in detail based on the summary described above.

<Detailed Configuration Example of Wireless Charging System>

In the third embodiment, a detailed configuration of the wireless charging system of the constant-rate stepping down type in FIG. 2 of the first embodiment will be described.

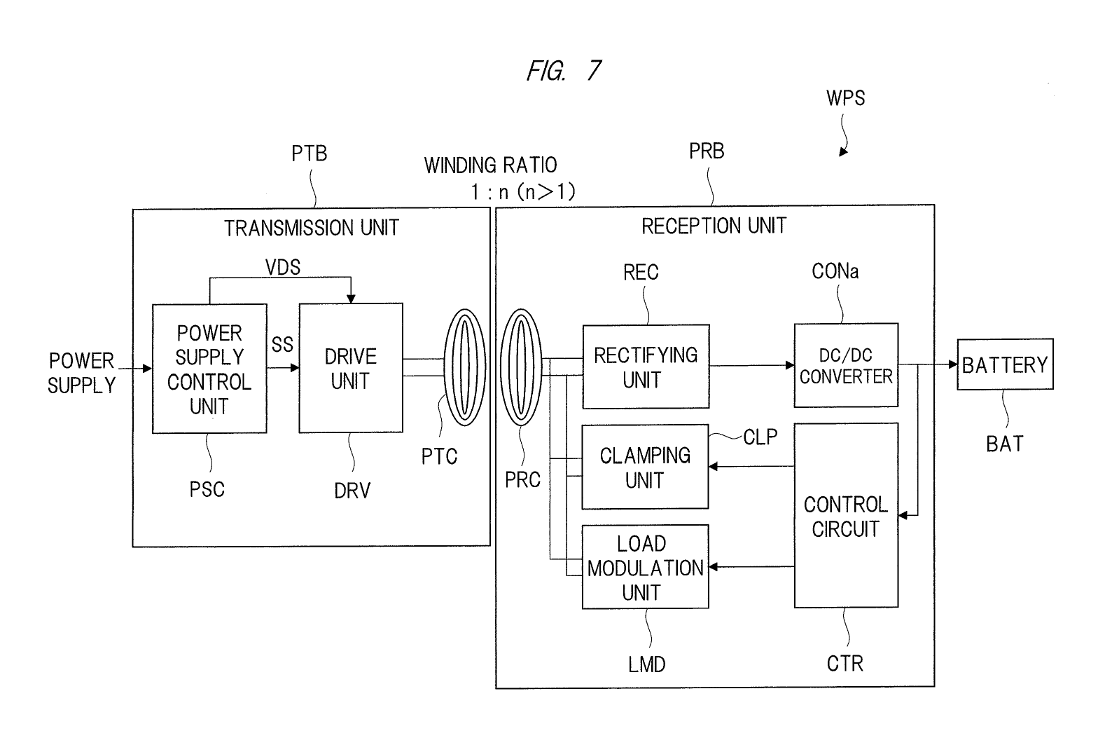

FIG. 7 is an explanatory diagram illustrating an example of a configuration of the wireless charging system of the constant-rate stepping down type according to the third embodiment.

The wireless charging system WPS is, as illustrated in FIG. 7, composed of a transmission unit PTB and a reception unit PRB. The transmission unit PTB includes, in the same manner as the transmission unit PTB in FIG. 2, a power supply control unit PSC, a driver unit DRV and a transmission coil PTC. Since the power supply control unit PSC, the driver unit DRV and the transmission coil PTC are the same as those in FIG. 2, descriptions thereof are omitted.

The power supply control unit PSC converts an inputted alternating voltage to a direct current and outputs the same to the driver unit DRV as a switching power supply VDS as well as creating and outputting a switching signal SS to the driver unit DRV.

Control of transmitting power is performed based on a control signal outputted from a control circuit CTR that will be described later. The control signal is communicated by a load modulation. The power supply control unit PSC changes, by the control signal, a voltage of the switching power supply VDS, switching frequency, a duty ratio of the switching signal SS, or else to perform power control.

The reception unit PRB includes a reception coil PRC, a rectifying unit REC, a DC/DC converter CONa, a control circuit CTR, a clamp unit CLP, and a load modulation unit LMD. Also, the rectifying unit REC, the DC/DC converter CONa, the control circuit CTR, the clamp unit CLP, and the load modulation unit LMD are configured as a semiconductor integrated circuit device such as power reception IC.

Note that, while the configuration includes the control circuit CTR provided in a power reception IC here, for example, a microcomputer or the like included in an electronic device may be provided with a function as the control circuit CTR.

Since the rectifying unit REC and the DC/DC converter CONa in the reception unit PRB are the same as those in FIG. 2 of the first embodiment, descriptions thereof are omitted. The control circuit CTR monitors voltage levels of the direct voltage outputted from the rectifying unit REC and a stepped-down voltage outputted from the DC/DC converter CONa. Then, when a monitored value of the voltage becomes larger than a setting value, the control circuit CTR determines that there is a trouble in the stepped down voltage outputted from the DC/DC converter CONa and outputs a trouble determination signal.

In addition, the control circuit CTR monitors voltage and current outputted from the DC/DC converter CONa and outputs, as a control signal, a difference between power the battery BAT needs and power actually supplied.

The power supply control unit PSC receives the control signal from the control circuit CTR and then adjusts transmitted power to eliminate the difference in power so that the battery BAT is optimally charged.

<Profile Example of Battery>

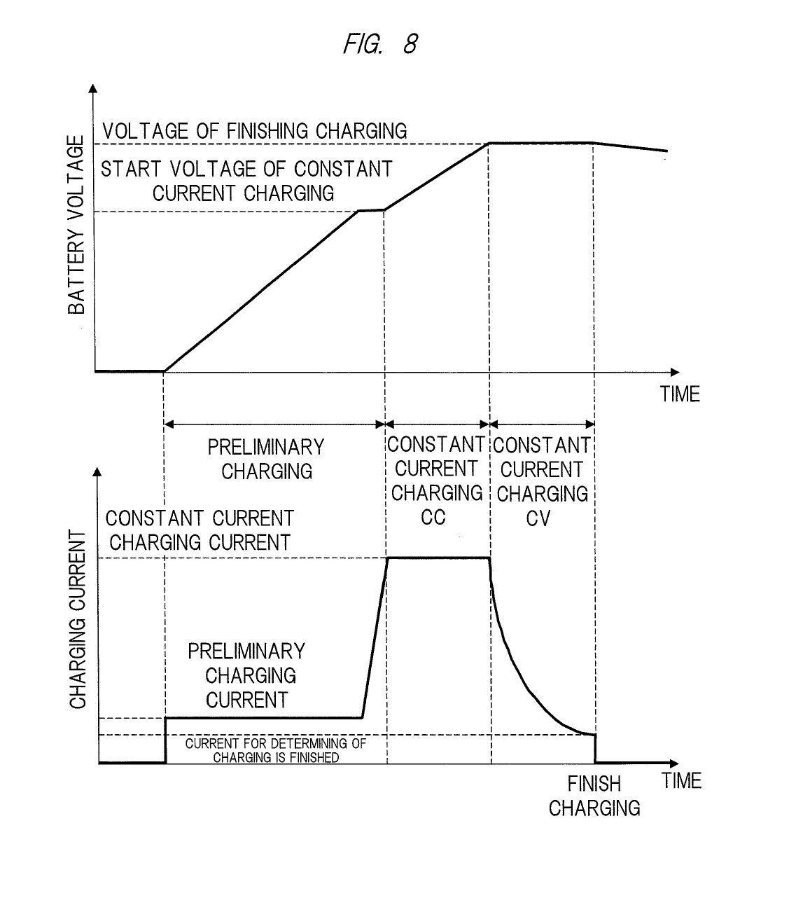

FIG. 8 is an explanatory diagram illustrating an example of a voltage profile/current profile of charging control of a battery by a control circuit that is provided to the wireless charging system in FIG. 7.

The control circuit CTR creates a control signal so that a battery voltage and a charging current of the battery BAT get close to a voltage profile and a current profile illustrated in FIG. 8 and outputs the control signal to the power supply control unit PSC to control the stepped down voltage outputted from the DC/DC converter CONa.

In this manner, an optimum charging management of the battery BAT is performed. The clamp unit CLP blocks an output voltage from the reception coil PRC when it receives a trouble determination signal outputted from the control circuit CTR.

The load modulation unit LMD is a circuit for subjecting the control signal outputted from the control circuit CTR to a load modulation. The load modulation unit LMD fluctuates a voltage or a current appearing at the transmission coil PTC by turning on and off a modulation capacitor, a resistance, or the like not illustrated. In the power supply control unit PSC, the voltage or current fluctuated by the load modulation unit LMD is detected, thereby performing communication.

<Operation Example of Wireless Charging System>

Subsequently, operation of the wireless charging system WPS in FIG. 7 is described.

In the wireless charging system WPS, the winding ratio of the transmission coil PTC and the reception coil PRC is 1:n. When the winding ratio of the transmission coil PTC and the reception coil PRC is 1:n, across the two ends of the reception coil PRC, a voltage n times as large as a voltage on the transmission coil PTC side is generated.

Then, an alternating voltage being n times larger is rectified and smoothed by the rectifying unit REC to create a direct voltage. Subsequently, the DC/DC converter CONa steps down the direct voltage outputted from the rectifying unit REC.

Since the stepping down ratio of input/output voltages of the DC/DC converter CONa is set to 1/n, the stepped down voltage outputted from the DC/DC converter CONa is substantially the same as a voltage generated on the transmission coil PTC side.

The stepped down voltage having been stepped down by the DC/DC converter CONa is outputted to the battery BAT to charge the battery BAT. The control circuit CTR monitors voltage and current outputted from the DC/DC converter CONa. The control circuit CTR controls a charging voltage and a charging current of the battery BAT follow the voltage profile and the current profile illustrated in FIG. 8.

When the voltage outputted from the DC/DC converter CONa, that is, the charging voltage becomes lower than that in the voltage profile, a control signal is outputted to make the voltage outputted from the DC/DC converter CONa to be higher.

Also in the wireless charging system WPS in FIG. 7, current flowing in the reception coil PRC and the rectifying unit REC can be reduced. Thus, loss can be significantly suppressed. In addition, as loss of the reception coil PRC and the rectifying unit REC is reduced, a temperature increase of the reception coil PRC can be suppressed.

Since a temperature increase of the battery BAT along with a temperature increase of the reception coil PRC etc. can be suppressed, charging can be efficiently performed.

Moreover, since the loss of the reception coil PRC and the rectifying unit REC is reduced, influence of temperature on the battery BAT can be reduced even when the charging current is increased for shortening the charging time of the battery BAT.

Further, in the same manner as the second embodiment, it is possible to reduce the wire diameter of the reception coil PRC and thus there is a merit in mounting coils when there is a limitation in thickness.

### Fourth Embodiment

In a wireless charging system according to a fourth embodiment, a voltage stepping down unit (voltage stepping down unit CONb) steps down a direct voltage outputted from a rectification unit to a substantially constant voltage.

Hereinafter, based on the summary mentioned above, the fourth embodiment will be described in detail.

<Detailed Configuration Example of Wireless Charging System>

In the fourth embodiment, a configuration of the wireless charging system of a constant voltage type in FIG. 6 of the second embodiment will be described in more details.

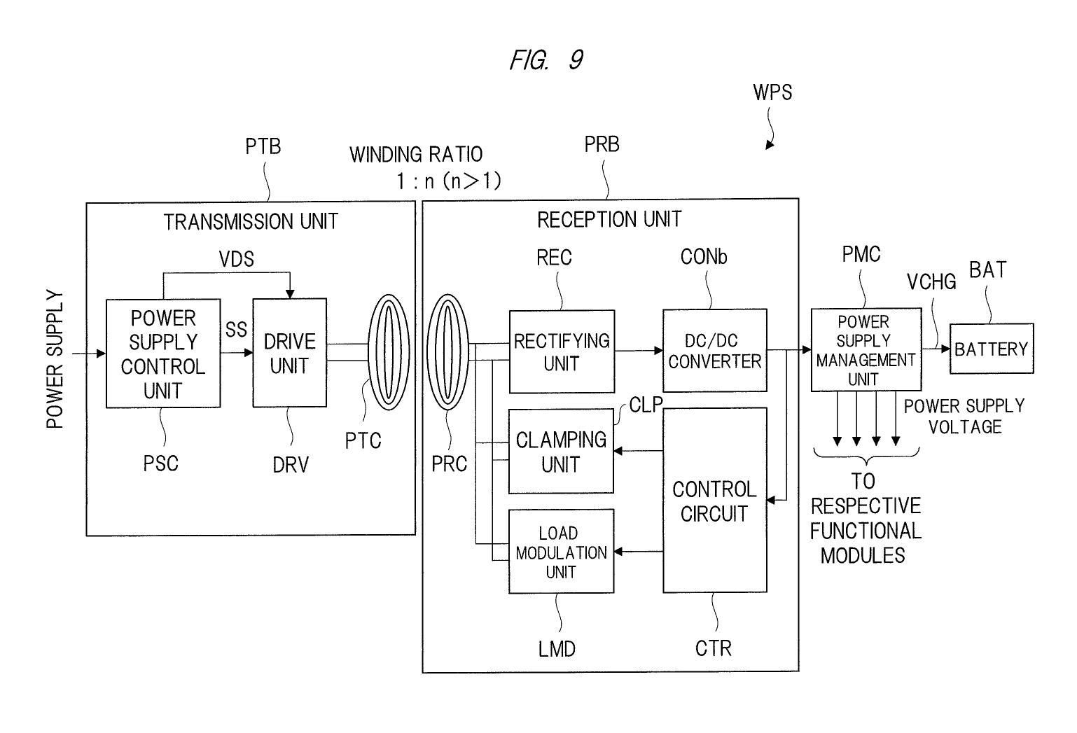

FIG. 9 is an explanatory diagram illustrating an example of the configuration of the wireless charging system of the constant voltage type according to the third embodiment.

This wireless charging system WPS is composed of a transmission unit PTB and a reception unit PRB as illustrated in FIG. 9. The transmission unit PTB includes, in the same manner as the transmission unit PTB in FIG. 2 of the first embodiment, a power control unit PSC, a driver unit DRV, and a transmission coil PTC. Since the driver unit DRV and the transmission coil PTC are the same as those in FIG. 2, descriptions thereof are omitted.

The power supply control unit PSC converts an inputted alternating voltage to a direct voltage and outputs the direct voltage to the driver unit DRV as a power supply for switching VDS and also creates and outputs a switching signal SS to the driver unit DRV.

Control of transmitted power is performed, in the same manner as that in FIG. 7 of the third embodiment, based on a control signal outputted from a control circuit CTR. The control signal is communicated by load modulation. The power supply control unit PSC controls power by changing, by the control signal, a voltage of the power supply for switching VDS, a switching frequency, a duty ratio of the switching signal SS, or else.

In addition, the reception unit PRB includes a reception coil PRC, a rectifying unit REC, a DC/DC converter CONb, a control circuit CTR, a clamp unit CLP, a load modulation unit LMD. Also, the rectifying unit REC, the DC/DC converter CONI, the control circuit CTR, the clamp unit CLP, and the load modulation unit LMD are configured as a semiconductor integrated circuit device such as power reception IC.

Since the rectifying unit REC and the DC/DC converter CONb in the reception unit PRB are the same as those in FIG. 6 of the second embodiment, descriptions thereof are omitted. The control circuit CTR monitors voltage levels of the direct voltage outputted from the rectifying unit REC and a stepped-down voltage outputted from the DC/DC converter CONb. Then, when a monitored value of the voltage becomes larger than a setting value, the control circuit CTR determines that there is a trouble in the stepped down voltage outputted from the DC/DC converter CONa and outputs a trouble determination signal.

A stepped down voltage outputted from the DC/DC converter CONb is inputted to the power supply management unit PMC. The power supply management unit PMC is, for example, a power management IC and is provided in electronic devices like mobile phones.

The power supply management unit PMC creates various power supply voltages from the stepped down voltage created by the DC/DC converter CONb and manages and supplies the power supply voltages to respective functional modules etc. included in an electronic device.

Further, the power supply management unit PMC creates a power supply for charging VCHG from the stepped down voltage created by the DC/DC converter CONb and supplies the power supply for charging VCHG to the battery BAT to perform and manage charging operation of the battery BAT. The power supply management unit PMC controls charging so that the power supply for charging VCHG follows the voltage profile and the current profile illustrated in FIG. 8.

The control unit CTR monitors the voltage and current outputted from the DC/DC converter CONb and outputs a control signal so that the voltage outputted from the DC/DC converter CONb is outputted at a substantially constant level.

The power supply control unit PSC receives the control signal from the control circuit CTR and then adjusts transmitted power based on the control signal.

The clamp unit CLP blocks an output voltage from the reception coil PRC when it receives a trouble determination signal outputted from the control circuit CTR. The load modulation unit LMD is a circuit for subjecting the control signal outputted from the control circuit CTR to a load modulation. The load modulation unit LMD fluctuates a voltage or a current appearing at the transmission coil PTC by turning on and off a modulation capacitor, a resistance, or the like not illustrated. In the power supply control unit PSC, the voltage or current fluctuated by the load modulation unit LMD is detected, thereby performing communication.

<Operation Example of Wireless Charging System>

Subsequently, operation of the wireless charging system WPS in FIG. 9 is described.

In the wireless charging system WPS, the winding ratio of the transmission coil PTC and the reception coil PRC is 1:n. When the winding ratio of the transmission coil PTC and the reception coil PRC is 1:n, across the two ends of the reception coil PRC, a voltage n times as large as a voltage on the transmission coil PTC side is generated.

Then, an alternating voltage being n times larger is rectified and smoothed by the rectifying unit REC to create a direct voltage. Subsequently, the DC/DC converter CONb steps down the direct voltage outputted from the rectifying unit REC.

Constant-voltage control is performed to make the stepped down voltage outputted from the DC/DC converter CONb at a substantially constant voltage level. The voltage stepped down by the DC/DC converter CONb is inputted to the power supply management unit PMC. Then, the battery is charged by the power supply for charging VCHG created by the power supply management unit PMC.

The control circuit CTR monitors the voltage and current outputted from the DC/DC converter CONb and outputs the control signal so that the stepped down voltage outputted from the DC/DC converter CONb is within a range of a previously set voltage level.

According to the foregoing, the current flowing in the reception current PRC and the rectifying unit REC can be also reduced and thus loss can be significantly suppressed. In addition, a temperature increase of the reception coil PRC can be suppressed and thus a temperature increase of the battery BAT along with the temperature increase of the reception coil PRC can be suppressed. Thus, charging can be efficiently performed.

Further, since the loss of the reception PRC and the rectifying unit REC is reduced, even when the charging current is increased for shorting the charging time of the battery BAT, influence by the temperature of the battery BAT can be reduced.

Moreover, in the same manner as the second embodiment, it is possible to reduce the wire diameter of the reception coil PRC and thus there is a merit in mounting coils when there is a limitation in thickness and so forth.

In the foregoing, the invention made by the inventor of the present invention has been concretely described based on the embodiments. However, it is needless to say that the present invention is not limited to the foregoing embodiments and various modifications and alterations can be made within the scope of the present invention.

What is claimed is:

1. A wireless charging system comprising:
a power transmission unit for transmitting power; and
a power reception unit for receiving the power transmitted from the power transmission unit in a non-contact manner and supplying the power to a receiving load,
wherein the transmission unit includes a power transmission coil for generating a magnetic field based on an alternating voltage supplied,
the power reception unit includes:
a power reception coil for generating an induction voltage by electromagnetic induction from the magnetic field generated by the power transmission coil;
a rectifying unit for rectifying and smoothing the induction voltage generated by the power reception coil; and
a voltage step-down unit for stepping down a direct voltage outputted from the rectifying unit,
a winding ratio of the power transmission coil and the power reception coil is 1:n where n is an integer larger than 1.

2. The wireless charging system according to claim 1,
wherein the voltage step-down unit steps down the voltage outputted from the rectifying unit to a voltage that is 1/n times as large as the voltage outputted from the rectifying unit.

3. The wireless charging system according to claim 1,
wherein the voltage step-down unit steps down the voltage outputted from the rectifying unit to a substantially constant voltage.

4. The wireless charging system according to claim 1,
wherein the number of n is 2 to 3.
